(19) United States
(12) Patent Application Publication
(10) Pub. No.: US 2010/0195825 A1
(43) Pub. Date: Aug. 5, 2010

(54) KEYSTROKE ENCRYPTION SYSTEM

(76) Inventor: Frank J. Cini, Nashua, NH (US)

Correspondence Address: Kristina M. Grasso;Kristina M. Grasso, Esq. PLLC, P.O. Box 162, Milford, NH, 03055, US

(21) Appl. No.: 12/366,032

(22) Filed: Feb. 5, 2009

(51) Int. Cl. H04L 17/02

(52) U.S. Cl. 380/52; 710/67

(57) ABSTRACT

A keyboard encryption system that enables encryption of keystrokes prior to their entry into a remote desktop. An encryption device is attached via a keyboard cable to a keyboard at one end and to a keyboard socket on a computer on the other end. A remote desktop connection allows for communication between the computer and a remote desktop server. The encryption device contains encryption software to encrypt each keystroke as it is received. The encryption device contains a unique serial number that allows it recognized by decryption software installed on the remote desktop server. The serial number is the primary key for the decryption software to decipher the encrypted keystrokes.

### FIELD OF THE INVENTION

The invention relates to computer security, and more particularly, to a keystroke encryption system that encrypts the keystrokes prior to entering a personal computer to a remote host.

### BACKGROUND OF THE INVENTION

Today, many millions of households and businesses in the U.S. and worldwide have adopted computer networking, which allows two or more computing devices to share data, peripherals, and/or an internet connection. Networks are built with a mix of computer hardware and computer software.

Remote desktop client software allows a user to sit at a computer and connect to a remote computer in a different location. For example, an individual can connect to their work computer from their home computer and have access to all of their programs, files, and network resources as though they were in front of their computer at work. A person can leave programs running at work and then, when they get home, they can see their work computer's desktop displayed on their home computer, with the same programs running.

With this increased ability to share information, computer security becomes extremely important in order to defend against hackers, viruses, and identity thieves. Computer security is the process of preventing and detecting unauthorized use of a computer. Prevention measures help to stop unauthorized users (also known as “intruders”) from accessing any part of the computer system.

Such access may be gained by the use of keyloggers. A keylogger is a tool used to capture a user's keystrokes and spy on their computer usage. Keyloggers, which are a form of spyware, may be installed by viruses or other types of malware. Thus, critical information, i.e.: passwords, social security numbers, account information, is vulnerable to interception when a user types on their keyboard.

The traditional approach to computer security is to create computing platforms, languages, and applications that enforce restrictions such that agents (i.e., users or programs) can only perform actions that have been allowed according to some specified security policy. The following techniques can be used in engineering secure systems. These techniques, while useful, do not ensure complete security.

Backups are a way of securing information; they are another copy of all the important computer files kept in another location. These files are kept on hard disks, CD-Rs, CD-RWs, and tapes. There is also a fourth option, which involves using one of the file hosting services that backs up files over the Internet for both business and individuals.

Anti-virus and anti-spyware software consists of computer programs that attempt to identify, thwart and eliminate computer viruses and other malicious software (malware). Typically, these are subscription services where updates are introduced periodically. If the software is not maintained, either by allowing the subscription to lapse or by not updating the software, then the local computer may be comprised. Sometimes, people cancel the automatic updates or virus scans because they interrupt their work, so these tools are often rendered useless.

Patches are updates to the operating system or third party software packages, that repair security vulnerabilities and other problems. Patching is different from virus protection and both should be done. Patching repairs vulnerabilities that can provide an entry point for viruses and other damaging programs.

Digital security devices generate a personal access code at a set time interval to reduce the possibility of an unauthorized log-on by hackers even in the unlikely event that your user ID and password for a particular website are compromised.

Firewalls are systems which help protect computers and computer networks from attack and subsequent intrusion by restricting the network traffic which can pass through them, based on a set of system administrator defined rules. However, until a user gets within the firewall, data is vulnerable.

Access authorization restricts access to a computer to group of users through the use of authentication systems. These systems can protect either the whole computer—such as through an interactive logon screen—or individual services, such as an FTP server. There are many methods for identifying and authenticating users, such as passwords, identification cards, and, more recently, smart cards and biometric systems.

Intrusion-detection systems can scan a network for people that are on the network but who should not be there or are doing things that they should not be doing, for example trying a lot of passwords to gain access to the network.

Some companies use graphical terminals, called “thin clients” to augment computer security. A thin client is a network computer with a read only operating system, which, in client/server applications, is designed to be especially small so that the bulk of the data processing occurs on the server. With a thin client, people are unable to install software and thus it is nearly impossible for virus to infect the computer. Thus, thin clients often do not contain anti-virus or anti-spyware software. Typically, the only programs installed are the remote desktop client software which is used to access the productivity applications. One drawback of using thin clients is that they do not allow for specialized software to be installed by an individual user.

Encryption is used to protect the message from the eyes of others. It can be done in several ways by switching the characters around, replacing characters with others, and even removing characters from the message. These have to be used in combination to make the encryption secure enough, that is to say, sufficiently difficult to crack. Public key encryption is a refined and practical way of doing encryption. It allows for example anyone to write a message for a list of recipients, and only those recipients will be able to read that message.

What is needed, therefore, is a mechanism for ensuring that keystrokes are encrypted before they enter the computer to a remote host.

### SUMMARY OF THE INVENTION

One goal of the present invention is to provide a keyboard encryption system that is compatible with any type of computer keyboard, any computer operating system, and any remote desktop protocol.

Another goal of the present invention is to provide a keyboard encryption system that requires less software to install and maintain.

A further goal of the present invention is to provide a keyboard encryption system that can be installed on a computer without jeopardizing existing information.

An additional goal of the present invention is to provide a keyboard encryption system that may be directly incorporated into the keyboard or keyboard port on the computer.

Yet another goal of the present invention is to provide a keyboard encryption system that is not dependent upon locally installed software in order to ensure security of the computer system.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram illustrating an overview of the keyboard encryption system of the present invention.

FIG. 2 is a diagram illustrating the flow of keystroke data using the keyboard encryption system of the present invention.

FIG. 3 is a flowchart illustrating the decision making process of the keyboard encryption system of the present invention.

FIG. 4 is a flowchart illustrating the decryption of scancodes of the keyboard encryption system of the present invention.

### DETAILED DESCRIPTION

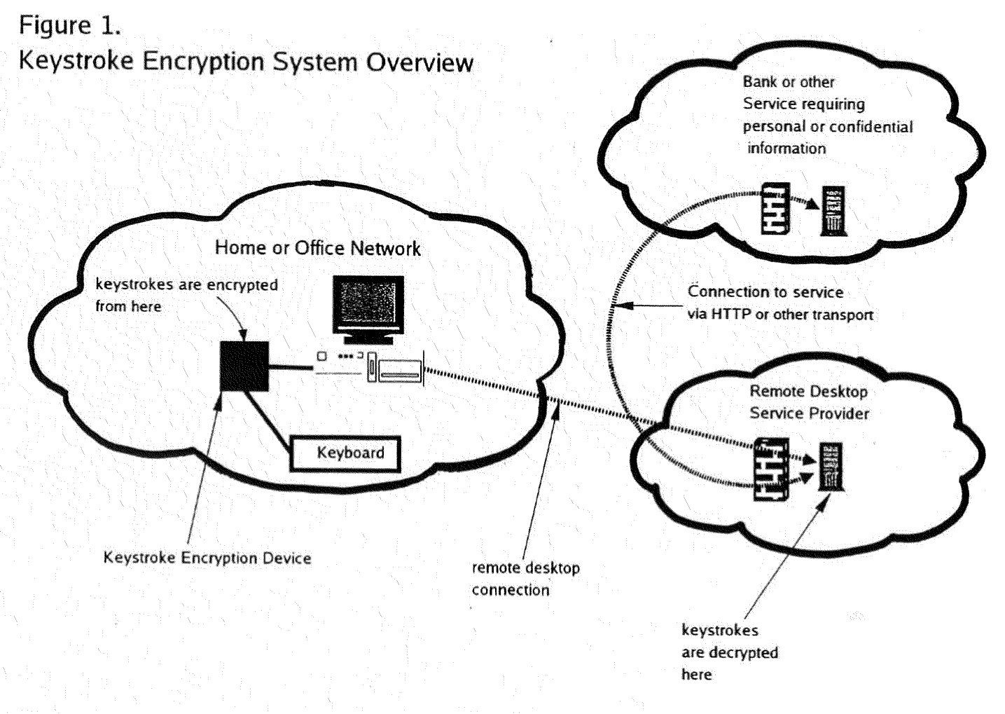

Referring to FIG. 1, the keyboard encryption system enables encryption of keystrokes prior to their entry into a remote desktop. A hardware device is attached via a keyboard cable to a keyboard at one end and to a keyboard socket on the computer on the other end. A remote desktop connection allows for communication between the remote desktop and a remote desktop server.

The hardware device encrypts each keystroke as it is received. An encryption algorithm, preferably a stream cipher, is used to encrypt the keystrokes. A stream cipher is a type of symmetric encryption algorithm. Stream ciphers encrypt individual characters of a plain text message one at a time, using an encryption transformation which varies with time. An alternative name is a state cipher, as the encryption of each digit is dependent on the current state. A stream cipher generates what is called a keystream (a sequence of bits used as a key). Encryption is accomplished by combining the keystream with the plaintext.

Also, the hardware device contains a serial number that is unique to the device which allows the device to be recognized by the remote decryption software installed on the remote desktop server. The serial number is the primary key, in a database of decryption keys, for the decryption software to decipher the keystrokes.

The remote desktop server contains the decryption software for deciphering the keystrokes. The decryption software is added to any of the software on the remote desktop server before the scancode is turned into an ASCii character. Typically, the decryption software is added to the keyboard driver of the operating system or the remote desktop server software.

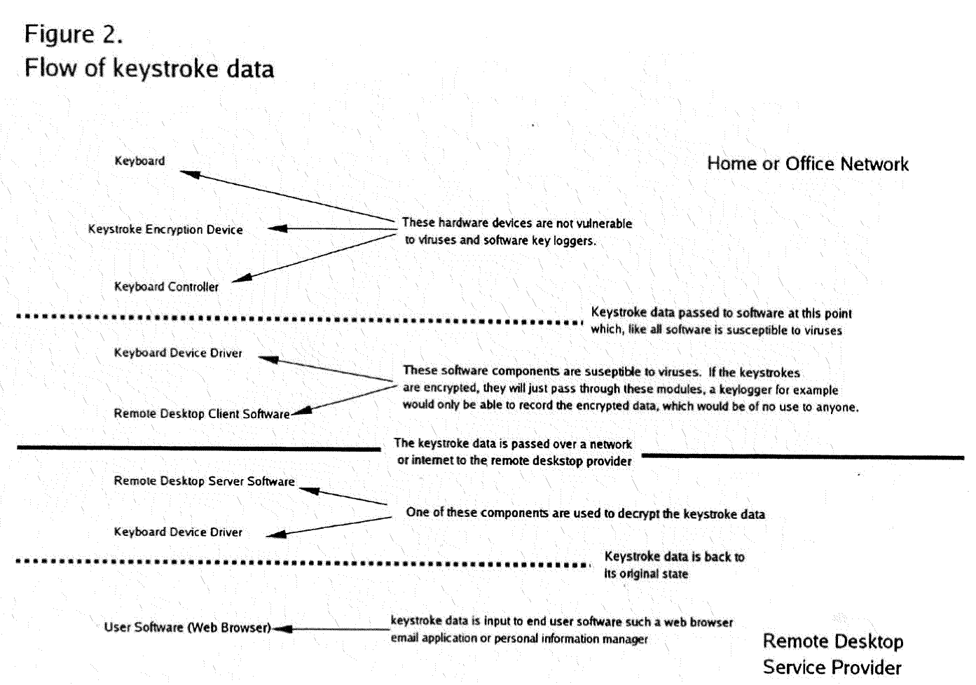

Referring to FIG. 2, there is a flow of keystroke data between the remote desktop and the remote desktop server. At the remote desktop, the keyboard, keystroke encryption device, and keyboard are not vulnerable to viruses and software keyloggers. However, when the keystroke data is passed to software on the remote desktop, it becomes susceptible to viruses. If the keystrokes are encrypted using the keystroke encryption device, then they will just pass through these modules. Thus, a key logger would only would only be able to record the encrypted data, which would be useless to a hacker.

The keystroke data is then passed over a network or the Internet to the remote desktop server. The remote desktop server software and/or the keyboard device driver may be used to decrypt the keystroke data. Once the keystroke data is decrypted, it can be inputted into end user software, such as email, web browser, or personal information manager.

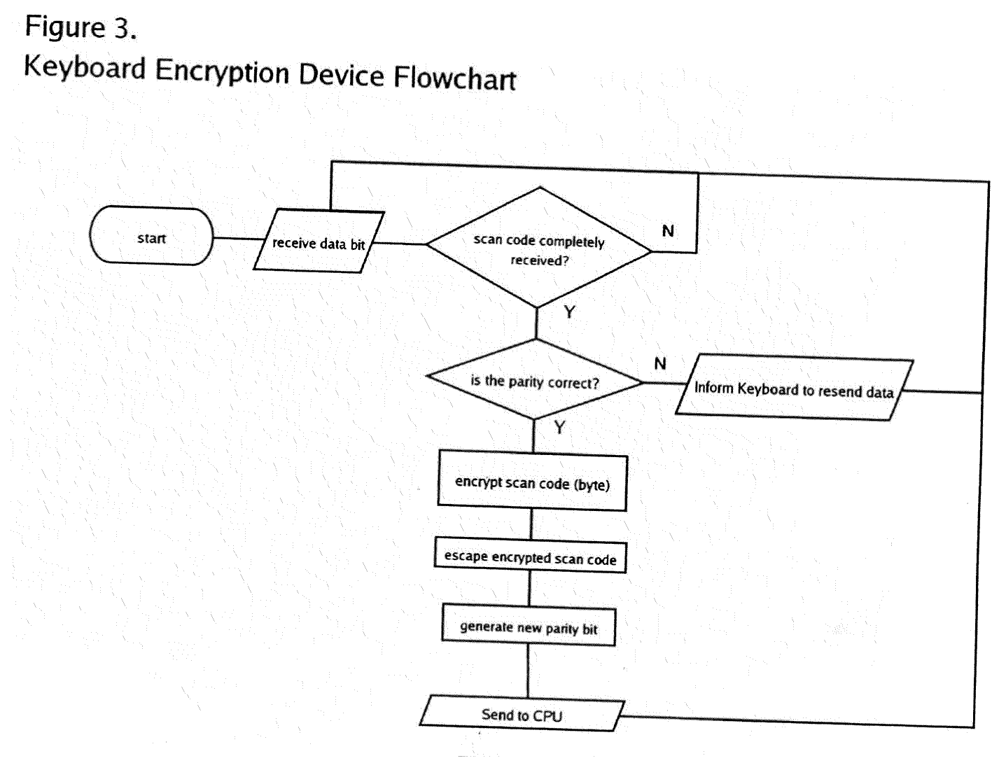

Referring to FIG. 3, the keyboard encryption device functions in a stepwise fashion. First, data is received one bit at a time until a complete scan code is received. The keyboard encryption device detects if the scan code is completely received. If not, a signal is sent informing the keyboard to resend the data. Once the scan code is completely received, the keyboard encryption device determines if the parity of the data bit is correct. A parity bit is a binary digit that indicates whether the number of bits with value of one in a given set of bits is even or odd. Parity bits are used as the simplest error detecting code. If the parity is not correct, a signal is sent informing the keyboard to resend the data. If the parity is correct, the scan code is then encrypted and escaped, then a new parity bit is generated and sent to the CPU.

An escaped encrypted code is where a pre-defined sequence of characters or codes are used to either do something special with the next set of characters or render a potentially harmful sequence of characters benign. For example, on pre-Pentium based personal computers, a “ctrl-alt-del” sequence would reboot the computer. Since the present invention manipulates key strokes, pressing “a-b-c” could potentially generate “ctrl-alt-del”, there has to be an escape mechanism from dangerous sequences, such as shortcut keys.

There are several methods by which to accomplish this. In one embodiment of the present invention, each byte (8 bits) is broken up into two “nibbles” (2×4 bits). Since 2⁴=16, only 16 characters need to be transmitted. Hex digits are used to encrypt the characters.

Hex is a numeral system with a radix, or base, of 16, usually written using the symbols 0-9 and A-F, or a-f. Its primary purpose is to represent the binary code in a format easier for humans to read, and acts as a form of shorthand, in which one hexadecimal digit stands in place of four binary bits.

Thus, sending “a-b-c”, which after encryption, may turn out to be “ctrl-alt-del” is rendered harmless by the escape encrypted scan code, which may send out “01a9e” instead.

This explanation of the escape encryption code may be used with any protocol as indicated in the following example:

Input: an already encrypted single byte scan code 0×00-0-0×FF (0-255 in decimal)

Step I: break apart the byte into its high order and low order nibbles. For example, if the encrypted scan code were 0×3c, that would yield a low order nibble of 0×c and high order nibble of 0×3.

| Encrypted character (hex) | High order nibble | Low order nibble |
|---|---|---|
| 0x1c | 0x1 | 0xc |
| 0x2d | 0x2 | 0xd |
| 0x0e | 0x0 | 0xe |
| 0x3c | 0x3 | 0xc |

Step II: substitute the scancode which represents its ascii value, so that the 0×c would display as ‘c’==>6 and 0×3 would display as ‘3’==>32

| Nibble from | Map to ascii | USB scancode (in decimal) |
|---|---|---|
| step I | character | (this is what is actually sent to the PC) |
| 0x00 | 0 | 39 |
| 0x01 | 1 | 30 |
| 0x02 | 2 | 31 |
| 0x03 | 3 | 32 |
| 0x04 | 4 | 33 |
| 0x05 | 5 | 34 |
| 0x06 | 6 | 35 |
| 0x07 | 7 | 36 |
| 0x08 | 8 | 37 |
| 0x09 | 9 | 38 |
| 0x0a | a | 4 |
| 0x0b | b | 5 |
| 0x0c | c | 6 |
| 0x0d | d | 7 |
| 0x0e | e | 8 |
| 0x0f | f | 9 |

This eliminates the possibility of harmful characters because the only sequences passing though the local PC would be those that evaluate to one of the following: 0,1,2,3,4,5,6,7,8,9,a,b,c,d,e,f

Step III: continue sending keystroke to local PC. From our example, send USB scancode 6, then 32.

At the other end, just before the keystrokes are decrypted, we put together the scancodes in reverse order.

It should be noted that in practice, this scheme has to be modified to suit the different protocols. For example, when using a USB keyboard: if the encrypted character comes out as 0×aa 0×bb, etc., then the keyboard controller may ignore the second sequence as it sees two consecutive key presses and no depress in between. So in this case we would use 0,1,2,3,4,5,6,7,8,9,a,b,c,d,e,f for the first byte, and g,h,i,j,k,l,m,n,o,p,q,r,s,t,u,v,w for the second to get around this issue.

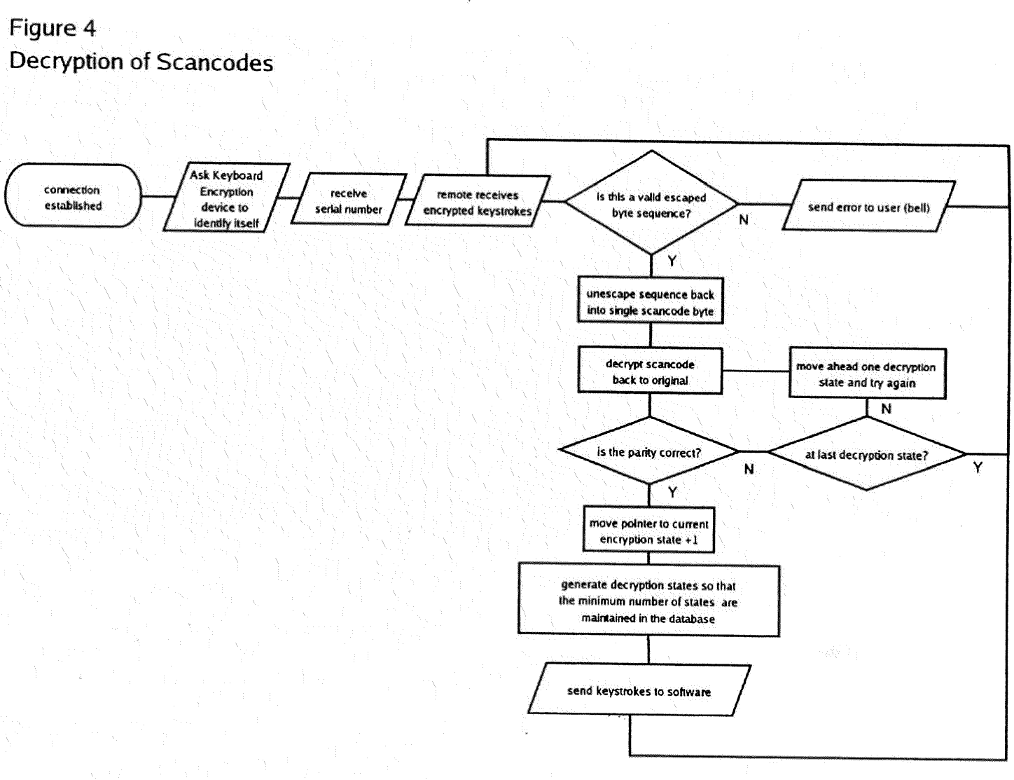

Referring to FIG. 4, the scan code is decrypted once it reaches the remote desktop server. First, a connection must first be established between the remote desktop and the remote desktop server. Once the connection is established, the server asks the keyboard encryption device to identify itself. The server then receives the serial number and the encrypted keystrokes. If the encrypted keystrokes are not received, then an error message is sent to the user. The server then determines if the encrypted keystrokes are a valid escaped byte sequence. If not, then an error message is sent to the user. Next, the escape byte sequence is turned back into a single scan code byte. The scan code is then decrypted back to the original keystrokes. The parity of the scan code is checked. If the parity is correct, the pointer is moved to the current encryption state plus one. Decryption states are generated so that the minimum number of states are maintained in the database. The decrypted keystrokes are then sent to the appropriate software requiring the transmitted information.

It should be noted that the hardware device may be turned off when using applications that do not require encryption. The hardware device is also turned off when the user needs to reboot the local computer. Additionally, the hardware device will cease functioning should tampering occur.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A keystroke encryption system comprising:
a keyboard for entering keystroke data; the keyboard having a cable to attach the keyboard to a CPU, the CPU having a socket to receive the cable;
a keystroke encryption device positioned between the keyboard and the CPU, the keystroke encryption device being attached to the cable at one end and the socket of the CPU at the other end;
an encryption software program installed on the keyboard encryption device;
a remote desktop server, the remote desktop server having a decryption software program installed on it; and
a remote desktop connection between the CPU and the remote desktop service provider.

2. The keyboard encryption system of claim 1 wherein the keyboard encryption device contains a serial number that is unique to the keyboard encryption device and may be identified by the decryption software.

3. The keyboard encryption system of claim 1 wherein the keyboard encryption device may be incorporated into the keyboard.

4. The keyboard encryption system of claim 1 wherein the encryption software encrypts each keystroke as it is received.

5. A method of encrypting keystroke data from a keyboard to a computer system, the keyboard and the computer system being coupled via a keystroke encryption device, the method comprising the steps of:
entering keystroke data via a keyboard, the data being received by the keystroke encryption device one bit at a time until a complete scan code is received;
detecting if the scan code is completely received;
determining if the parity of the data bit is correct;
encrypting the scan code;
generating a new parity bit; and
sending the new parity bit to the CPU.

6. A method of decrypting keystroke data received from a keystroke encryption device, the method comprising the steps of:
establishing a connection between a computer system containing the keyboard encryption device and remote desktop server;
identifying the keyboard encryption device via a unique serial number;
receiving the unique serial number and encrypted keystrokes from the keystroke encryption device;
determining if the encrypted keystrokes are a valid escaped byte sequence;
turning the escape byte sequence into a single scan code byte; decrypting the scan code back to the original keystrokes;
checking the parity of the scan code;
moving to the next encryption state; and
sending the decrypted keystrokes to the software requiring the transmitted information.

7. A system for encrypting and transferring keystroke data through a local computer and receiving and retrieving the original unencrypted keystroke data on a remote computer system comprising:
a device electrically placed between a keyboard and a local computer system, the device being capable of relaying and modifying a plurality of electrical signals between the keyboard and the local computer system;
a piece of software which receives a plurality of bits of encrypted data, retrieves a plurality of keystrokes from the encrypted data and directs the keystrokes as input into a remote computer system; and
a remote access client that communicates with a protocol of prior art.

8. The system of claim 7 wherein the remote access client may be modified by the software and serve the same function thereof.

9. The system of claim 7 wherein the device contains an encryption system.

10. The system of claim 7 wherein the device contains a unique code to identify itself to the software.

11. The system of claim 8 wherein the device contains a unique code to identify itself to the remote access client.

12. The system of claim 7 wherein the software has an identical cipher state to the device.

13. The system of claim 12 wherein the cipher state of the software is synchronized to the cipher state of the device.

14. The system of claim 7 wherein the device has a normal mode in which the keystrokes are unmodified by the device.

15. The system of claim 7 wherein the device identifies itself to the remote access client by sending an identifying sequence that allows the remote access client to recall the cipher state.

16. A method of encrypting and transferring keystroke data through a local computer and receiving and retrieving the original unencrypted keystroke data on a remote computer system comprising the steps of:
electronically placing a device between a keyboard and a local computer system;
relaying and modifying a plurality of electrical signals between the keyboard and the local computer system;
receiving a plurality of bits of encrypted data via a piece of software;
retrieving a plurality of keystrokes from the encrypted data;
directing the keystrokes as input into a remote computer system; and
communicating with a protocol of prior art on a remote access client.

17. The method of claim 16 wherein the device has a secure mode, the secure mode comprising the steps of:
encrypting the keystrokes using a predetermined cipher and a pre-seeded and initialized state;
encapsulating the cipher encoded data in a benign sequence of keystroke characters;
transforming the benign sequence of keystroke characters so that it will pass through to the local computer system without modifying its operation;
sending the benign sequence of keystroke characters to the remote access client; and
transforming and decrypting the benign sequence of keystroke characters.
